(19) United States
(12) Patent Application Publication
(10) Pub. No.: US 2008/0155403 A1
(43) Pub. Date: Jun. 26, 2008

(54) METHODS AND COMPUTER PROGRAM PRODUCTS FOR USING PARTICIPANT-SPECIFIED PRIORITIES OF COLLABORATIVE EVENTS TO INDICATE COMPOSITE AVAILABILITY LEVELS FOR EACH OF A PLURALITY OF TIMESLOTS

(75) Inventors: Veronique LeShan Tice Moses, Raleigh, NC (US); Lucinio Santos, Durham, NC (US); Manjula Seelam, Morrisville, NC (US); Shaneice N. Jordan, Durham, NC (US); Thomas R. Haynes, Apex, NC (US)

Correspondence Address: CANTOR COLBURN LLP - IBM RSW, 20 Church Street, 22nd Floor, Hartford, CT, 06103, US

(73) Assignee: INTERNATIONAL BUSINESS MACHINES CORPORATION, New York, NY (US)

(21) Appl. No.: 11/615,057

(22) Filed: Dec. 22, 2006

(51) Int. Cl. G06F 3/00

(52) U.S. Cl. 715/700

(57) ABSTRACT

Receiving participant-specified priority levels for each of a plurality of collaborative events. The participant-specified priority levels are used to calculate relative availability levels for each of a plurality of participants in each of a plurality of timeslots. For each of a plurality of timeslots, the relative availability levels for each of the plurality of participants is consolidated to provide a composite timeslot availability level. Composite timeslot availability levels for each of the plurality of timeslots are displayed on a graphical user interface. A collaborative event is scheduled by selecting one or more timeslots having a higher composite availability level relative to other timeslots.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

The present invention relates generally to software for scheduling collaborative events and, more specifically, to methods and computer program products for using participant-specified priorities of collaborative events to indicate composite availability levels for each of a plurality of timeslots.

2. Description of Background

Various software programs exist for scheduling collaborative events. These programs may provide an indication of availability in the form of a graphical interface for each event participant. The graphical interface displays sets of bars on a calendar to indicate a participant's free time and busy time. An illustrative example of such a program is disclosed in U.S. Publication No. 2004/0093290. By comparing graphs for each of a plurality of event participants, a meeting planner attempts to select a time and date for the event when all participants will be free. From time to time, a participant's calendar may include numerous previously scheduled events, with the effect that any new event would have to be scheduled days, weeks, or months into the future. Since participant calendars are equipped to display only two levels of granularity in the form of available timeslots and unavailable timeslots, no mechanism is provided for overriding a previously scheduled but unimportant meeting with a newly scheduled, important meeting.

Another prior art method for scheduling collaborative events is disclosed in U.S. Pat. No. 6,781,920. A meeting scheduler applies a numerical priority to a meeting invitation for a meeting that will be held at a predetermined timeslot. If a meeting invitation already exists in the recipient's calendar for that timeslot and with a lower priority as set by the meeting scheduler, the new meeting will be automatically scheduled and the previously scheduled meeting overridden. Otherwise the new meeting will not be scheduled for the recipient. Unfortunately, the meeting scheduler is not made aware of the relative priorities of other meetings on the recipient's calendar, with the effect that the scheduler might unknowingly override an extremely important meeting that the recipient must attend with a less important meeting deemed urgent by the scheduler.

Yet another prior art method for scheduling collaborative events is disclosed in U.S. Publication No. 2005/0102245. A meeting scheduler offers a plurality of possible meeting times to participants, associating each meeting time with a corresponding preference such as preferred, acceptable, unfavored, and unacceptable. Participants then select a time that is best for them from the list of possible meeting times prepared by the meeting scheduler. Unfortunately, this method only considers a limited number of timeslots proposed by the meeting scheduler. If all of the suggested timeslots are occupied by previously scheduled meetings which participants have to attend, a number of participants may miss the meeting.

Accordingly, what is needed is a collaborative event scheduling method which indicates relative availabilities for each of a plurality of proposed timeslots based upon input received from event participants.

### SUMMARY OF THE INVENTION

The shortcomings of the prior art are overcome and additional advantages are provided by receiving participant-specified priority levels for each of a plurality of collaborative events. The participant-specified priority levels are used to calculate relative availability levels for each of a plurality of participants in each of a plurality of timeslots. For each of a plurality of timeslots, the relative availability levels for each of the plurality of participants is consolidated to provide a composite timeslot availability level. Composite timeslot availability levels for each of the plurality of timeslots are displayed on a graphical user interface. A collaborative event is scheduled by selecting one or more timeslots having a higher composite availability level relative to other timeslots.

Computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution wherein composite timeslot availability levels for each of a plurality of timeslots are displayed on a graphical user interface, thereby permitting a collaborative event to be scheduled by selecting a timeslot having a higher composite availability level relative to one or more other timeslots.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary method for using participant-specified priorities of collaborative events to indicate composite availability levels for each of a plurality of timeslots.

FIG. 2 shows an illustrative graphical user interface showing composite timeslot availability levels for each of a plurality of timeslots prepared using the method of FIG. 1.

Like reference numerals are used to refer to like elements throughout the drawings. The detailed description explains the preferred embodiments of the invention, together with advantages and features, by way of example with reference to the drawings.

### DETAILED DESCRIPTION OF THE INVENTION

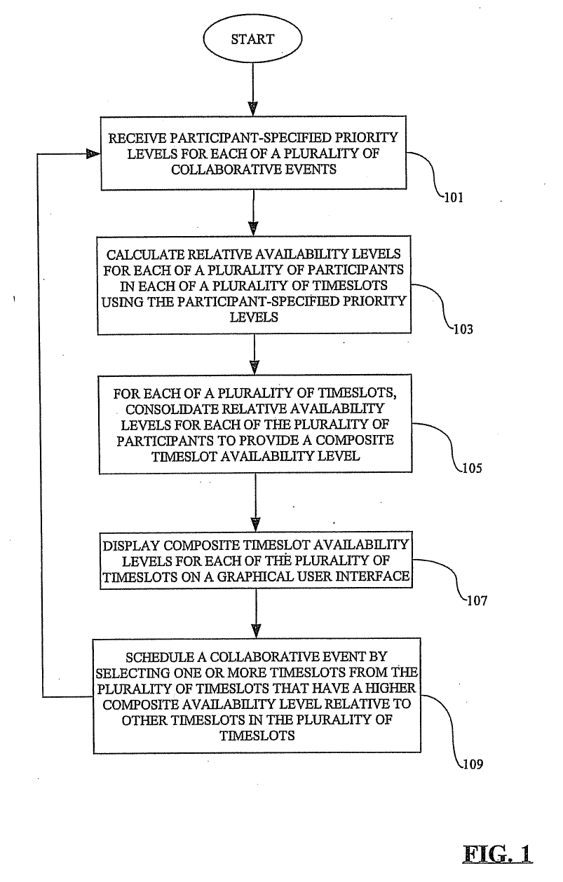

FIG. 1 illustrates an exemplary computer-executable method for using participant-specified priorities of collaborative events to indicate composite availability levels for each of a plurality of timeslots. The procedure commences at block 101 where participant-specified priority levels for each of a plurality of collaborative events are received. For purposes of illustration, priority levels 1 through 10 may be defined where 1 represents the lowest priority and 10 represents the highest priority. For a first collaborative event, a priority level of 7 may be received from a first participant, and a priority level of 5 may be received from a second participant. For a second collaborative event, a priority level of 2 may be received from the first participant and a priority level of 8 may be received from the second participant. These received priority levels are provided only as illustrative examples. Ten priority levels need not be provided, as any number of levels greater than one may be employed. Alternatively or additionally, priorities could be defined such that lower numbers correspond to higher priority levels. Additionally or alternatively, priority levels could be specified in terms of alphabetic, alphanumeric, or descriptive labels.

The procedure continues to block 103 where relative availability levels are calculated for each of a plurality of participants in each of a plurality of timeslots using the participant-specified priority levels received at block 101. For example, four relative availability levels could, but need not, be provided in the form of “very available”, “somewhat available”, “somewhat unavailable”, or “very unavailable”. The calculation of relative availability levels from participant-specified priority levels may, but need not, be performed by mapping each of respective participant-specified priority levels to a corresponding relative availability level, or by using a mathematical formula specifying relative availability level as a function of participant-specified priority level. Use of four relative availability levels is not required, as any number of two or more availability levels may be employed. Moreover, these availability levels could be specified using numbers, alphanumeric codes, descriptive words, or various combinations thereof.

Using an illustrative mapping process, participant-specified priority levels of 1 and 2 may be mapped to “very available”, whereas participant-specified priority levels of 3, 4, and 5 may be mapped to “somewhat available”, participant-specified priority levels of 6, 7, and 8 may be mapped to “somewhat unavailable”, and participant-specified priority levels of 9 and 10 may be mapped to “very unavailable”. Optionally, one or more individual participants are able to specify the mapping procedure or mathematical formula used to calculate relative availability levels from participant-specified priority levels. This optional specification may be applied only to a single participant or, alternatively, it may be applied to all participants or to a selected subset of participants.

At block 105, for each of a plurality of timeslots, relative availability levels for each of the plurality of participants is consolidated to provide a composite timeslot availability level. This consolidation could, but need not, be performed by averaging the relative availability levels of all participants for a given timeslot. Alternatively or additionally, this consolidation could, but need not, be performed by determining a weighted average of the relative availability levels of all participants for a given timeslot, wherein the availability levels of some participants are weighted less than or more than the availability levels of other participants when calculating an average timeslot availability level.

As an alternative or in addition to determining a consolidated availability level for each of a plurality of timeslots by averaging the relative availability levels for a set of participants, it is also possible to calculate the standard deviation of relative availability levels for all participants in a given timeslot. The standard deviation may provide a meeting planner with valuable information concerning the optimum time to schedule a meeting. For example, consider Table 1 which shows relative availability levels for Participant A and Participant B in each of a plurality of time slots including a first time slot and a second time slot:

TABLE 1

| | First Time Slot | Second Time Slot |
|---|---|---|
| PARTICIPANT A | 4 | 2 |
| PARTICIPANT B | 6 | 8 |

Observe that the average availability levels for the first time slot and the second time slot are both the same—namely, 5. However, the standard deviation of the relative availability levels for Participants A and B is much lower in the first time slot than in the second time slot. In other words, whereas Participants A and B both have relative availability levels in the first time slot (4 and 6) that are close to the average availability level (5), it should be noted that Participants A and B have relative availability levels in the second time slot (2 and 8) that are further removed from the average availability level of 5. Accordingly, a meeting planner might prefer scheduling a meeting during the first time slot so as to avoid overwriting a very important meeting for Participant B during the second time slot.

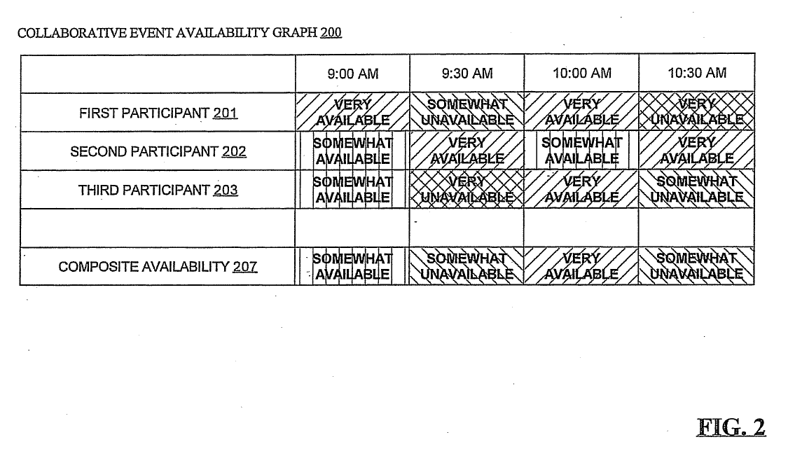

At block 107, composite timeslot availability levels for each of the plurality of timeslots are displayed on a graphical user interface. An example of such an interface is shown in FIG. 2, to be described in greater detail hereinafter. Next, at block 109 (FIG. 1), a collaborative event is scheduled by selecting one or more timeslots from the plurality of timeslots that have a higher composite availability level relative to other timeslots in the plurality of timeslots.

FIG. 2 shows an illustrative graphical user interface showing composite timeslot availability levels for each of a plurality of timeslots prepared using the method of FIG. 1. The graphical user interface is provided in the form of a collaborative event availability graph 200. For each of a plurality of participants including a first participant 201, a second participant 202, and a third participant 203, collaborative event availability graph 200 displays a relative availability level for that participant in each of a plurality of timeslots. In the example of FIG. 2, these timeslots are labeled as 9:00 AM, 9:30 AM, 10:00 AM, and 10:30 AM, with the understanding that the 9:00 AM timeslot commences at 9:00 AM and ends just prior to commencement of the next timeslot at 9:30 AM, the 9:30 AM timeslot ends just prior to commencement of the next timeslot at 10:00 AM, and so on. These timeslots need not be a half hour in length, as any convenient length of time may be used for the timeslots, and all timeslots need not be of the same duration.

Considering the 9:00 AM timeslot, first participant 201 is “very available”, whereas second participant 202 and third participant 203 are only “somewhat available”. These availability levels are used to calculate a composite availability 207, illustratively by assigning each availability level a numeric value and averaging these numeric values. For example, “very available” could be assigned a numeric value of +2, “somewhat available” a value of +1, “somewhat unavailable” a value of −1, and “very unavailable” a value of −2. These numeric values are presented for illustrative purposes only, as other numeric values could be assigned (such as “1” for “very unavailable”, “2” for “somewhat unavailable”, “3” for “somewhat available”, “4” for “very available”).

A composite availability level may be determined by choosing an availability level having a numeric value closest to the average value calculated from the availability levels of each individual participant. For example, in the 9:00 AM timeslot, first participant 201 is “very available”, corresponding to a value of +2. Second and third participants 202 and 203 are somewhat available, corresponding to values of +1. Adding these values (2 plus 1 plus 1) yields 4 which, when divided by three to determine the average, provides a value of 1.3. In this example, the relative availability level closest to 1.3 is “somewhat available” (having a value of 1), so “somewhat available” represents composite availability 207 for the 9:00 AM timeslot. Similar composite availability levels are calculated for the 9:30 AM, 10:00 AM, and 10:30 AM timeslots.

Using collaborative event availability graph 200, a meeting planner can readily visualize one or more timeslots that are optimum for a meeting based upon the priorities and previously existing commitments of all participants. Alternatively or additionally, one or more optimum timeslots for the meeting may be automatically calculated based upon composite availabilities for each of a plurality of timeslots.

The capabilities of the present invention can be implemented in software, firmware, hardware or some combination thereof. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for indicating a composite availability level for each of a plurality of timeslots based upon input received from a plurality of collaborative event participants, the method including:
receiving participant-specified priority levels for each of a plurality of collaborative events;
calculating relative availability levels for each of a plurality of participants in each of a plurality of timeslots using the participant-specified priority levels;
for each of the plurality of timeslots, consolidating the relative availability levels for each of the plurality of participants to provide a composite timeslot availability level; and
displaying composite timeslot availability levels for each of the plurality of timeslots on a graphical user interface.

2. The method of claim 1 further including scheduling a collaborative event by selecting one or more timeslots having a higher composite availability level relative to other timeslots.

3. The method of claim 1 wherein consolidating is performed by assigning a numeric value to each of the relative availability levels in a timeslot, calculating an average of the assigned numeric values, and determining a composite relative availability level corresponding to the calculated average.

4. The method of claim 1 wherein consolidating is performed by assigning a numeric value to each of the relative availability levels in a timeslot, calculating a standard deviation of the assigned numeric values, and determining a composite relative availability level corresponding to the calculated standard deviation.

5. The method of claim 1 wherein calculating relative availability levels for each of a plurality of participants in each of a plurality of timeslots is performed by mapping each of respective participant-specified priority levels to a corresponding relative availability level.

6. The method of claim 1 wherein the relative availability levels include “very available”, “somewhat available”, “somewhat unavailable”, and “very unavailable”.

7. A computer program product for indicating a composite availability level for each of a plurality of timeslots based upon input received from a plurality of collaborative event participants, the computer program product comprising a storage medium readable by a processing circuit and storing instructions for execution by the processing circuit for facilitating a method comprising:
receiving participant-specified priority levels for each of a plurality of collaborative events;
calculating relative availability levels for each of a plurality of participants in each of a plurality of timeslots using the participant-specified priority levels;
for each of the plurality of timeslots, consolidating the relative availability levels for each of the plurality of participants to provide a composite timeslot availability level; and
displaying composite timeslot availability levels for each of the plurality of timeslots on a graphical user interface.

8. The computer program product of claim 7 further including instructions for scheduling a collaborative event by selecting one or more timeslots having a higher composite availability level relative to other timeslots.

9. The computer program product of claim 7 further including instructions for consolidating by assigning a numeric value to each of the relative availability levels in a timeslot, calculating an average of the assigned numeric values, and determining a composite relative availability level corresponding to the calculated average.

10. The computer program product of claim 7 further including instructions for consolidating by assigning a numeric value to each of the relative availability levels in a timeslot, calculating a standard deviation of the assigned numeric values, and determining a composite relative availability level corresponding to the calculated standard deviation.

11. The computer program product of claim 7 further including instructions for calculating relative availability levels for each of a plurality of participants in each of a plurality of timeslots by mapping each of respective participant-specified priority levels to a corresponding relative availability level.

12. The computer program product of claim 7 wherein the relative availability levels include “very available”, “somewhat available”, “somewhat unavailable”, and “very unavailable”.
